(19) United States
(12) Patent Application Publication
(10) Pub. No.: US 2003/0063715 A1
(43) Pub. Date: Apr. 3, 2003

(54) Movable barrier operator with back-up battery monitoring and notification device

(75) Inventor: Neil Peplinski, Schaumburg, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group

(21) Appl. No.: 09/966,341

(22) Filed: Sep. 28, 2001

(51) Int. Cl. H04M 1/64; H04M 1/00

(52) U.S. Cl. 379/67.1; 379/88.22; 379/413

(57) ABSTRACT

A battery and component monitoring and notification device for a garage door operator is shown that provides telephone or internet notification when back-up batteries or other components require replacement. The device uses a programmable information processor to monitor the condition of back-up batteries or other components, actuates a telephone line interface to dial out a stored telephone number, and then actuates a voice control chip to play a stored telephone message. The telephone number and message are inputted by the user. The device may also provide notification over the internet by telephone line or other internet connection system. In addition, the device uses one or more battery chargers that each operate in one of two charging modes depending on the level of charging current to each battery.

### BACKGROUND OF THE INVENTION

The invention relates to movable barrier operators for operating movable barriers or doors. More particularly, it relates to garage door operators with a back-up battery monitoring and automatic service call system, which recharges the batteries and provides telephone or internet notification when back-up batteries or other components require replacement.

One major problem with garage door operators is the need for preventative maintenance for battery back-ups and other components. Battery back-ups, such as sealed lead acid batteries, are used to provide a source of power if for some reason there is an electrical power outage, or other loss of externally supplied power. The batteries are useful, however, only as long as they have sufficient voltage to operate the garage door operator. Even if the back-up batteries are never needed to operate the garage door operator, the battery charges will still deteriorate over time. Thus, they may need recharging or replacement prior to a power outage.

One way to address this problem is to recharge the batteries so that they are constantly maintained in a charged state and are ready for use. Conventionally, batteries that stand idle for long periods of time are initially charged at a constant high voltage. Over time, as the charge on the battery increases, the charging current is reduced to a “trickle” and the battery is charged more slowly. Trickle charging involves applying a continuous low level of current to the battery.

Garage door operators with battery rechargers typically apply a constant recharging voltage, which results in relatively high current trickle charging. Even though high current trickle charging helps maintain the charge on a battery, it has a negative impact on the battery itself. High current trickle charging shortens battery life because it constantly activates the electrolyte materials on the battery's electrodes. In turn, this results in elevated battery temperatures, which leads to loss of electrolyte by evaporation and to a general deterioration in the condition of the battery. In addition, conventional trickle charging often does not take into account high temperatures that may lead to further deterioration of the battery. High current trickle charging, especially at relatively high temperatures, may reduce battery life by years.

In addition to battery recharging, there is a need to inform the user or other individual when a battery must be replaced. One way to provide such notification is to provide an indicator light or audio signal to inform the user that the batteries are in need of service. Because the garage door operator usually operates by externally supplied electrical power and because power outages are relatively infrequent, however, the user may not address the problem immediately. There may be no immediate need to obtain a battery replacement because the timing of upcoming power outages is uncertain. The owner may postpone acting on the problem and, in time, may forget about or ignore the problem. By not acting, the owner may be unable to operate the garage door operator at an inopportune and aggravating time, such as during an electrical power failure.

For example, it has become commonplace for homeowners to leave their homes while carrying only garage door transmitters to allow them to reenter. These homeowners, however, may later find themselves locked out of their homes if there is an electrical power failure. Without a battery back-up in the garage door operator, the homeowner may not be able to reenter the home if the garage door operator is subject to a power failure. Accordingly, there is a need for a system that can monitor battery voltage and other components, that can maintain back-up batteries in a charged state for extended periods of time, and that can initiate a stored service call when battery or component replacement is required.

### SUMMARY OF THE INVENTION

The present invention provides back-up batteries for a system such as a garage door operator. The garage door operator itself generally includes a head unit mounted to the ceiling of a garage, a motor, a transmission rail for raising and lowering a garage door, door rails along which the sides of a garage door are moved, and a controller located in the head unit that is operative to energize the motor to raise and lower the door. The garage door operator system also includes a hand-held transmitter unit adapted to send signals to an antenna positioned on the head unit and a wall control connected to the head unit. Components of the garage door operator system are ordinarily powered by an external alternating current source.

The garage door operator system uses one or more batteries to provide back up power to the garage door operator in case there is an electrical power outage. The present invention provides a system, such as for a garage door operator, that monitors back-up batteries and other components and initiates a stored service call to a dealer or other predetermined individual when the batteries or other components require replacement. In addition, the system uses one or more battery chargers to maintain the back-up batteries in a charged state and to extend the life of the back-up batteries. The back-up battery system includes the following components: one or more batteries, one or more battery-charging circuits, one or more battery voltage sensing circuits, a programmable information processor, a telephone line interface or other internet connection system, and a voice control chip.

The batteries are generally maintained in a charged state by battery-charging circuits. The present invention uses a modified version of trickle charging to maintain the charge on a battery while extending battery life. More specifically, the battery-charging circuits apply one of two predetermined charging voltages: an initial charging voltage and a lower float voltage. The lower float voltage prevents loss of electrolyte and battery deterioration that would otherwise occur if the initial charging voltage were continuously applied. These battery-charging circuits maintain a sufficient charge on the battery to operate a garage door operator in case of an external power failure while preventing the battery from trickle charging at too high a rate, which would reduce the effective life of the battery. Each battery charger includes the following components: comparator, voltage regulator, and temperature-dependent current source.

Even though the back-up batteries are recharged in this manner, the output voltages of these batteries will still deteriorate over time. The back-up battery circuit uses one or more battery voltage sensing circuits to detect when the batteries need replacement. A programmable information processor is operatively connected to the battery voltage sensing circuits and determines when battery output voltage falls below a predetermined level.

In turn, the programmable information processor actuates a telephone line interface to dial a stored telephone number, such as the telephone number of a garage door operator dealer. Alternatively, the present invention may use some internet connection system. The garage door operator circuit preferably includes a keypad with ten number keys (0-9), a record key, and a program key. The keypad allows a user to input one or more telephone numbers to be dialed and one or more telephone messages to be transmitted. A “record” key allows the user to record one or more phone messages, a “program” key allows the user to enter one or more phone numbers to be called by using the number keys.

The programmable information processor transmits a stored telephone message to a dealer (or other pre-selected individual) by interfacing with a telephone line interface, which may include an internet connection system, and with a voice control chip. The programmable information processor programs the telephone line interface to dial out touch tone codes for a stored telephone number or actuates the internet connection system. The programmable information processor also interfaces with the voice control chip, which is utilized for recording and playback of a voice message. After a telephone number is dialed, a stored message is transmitted.

These and other advantage are realized with the described battery recharging, battery and component monitoring, and automatic service call system. The invention's advantages may be best understood from the following detailed description considered in conjunction with the accompanying drawings and with the computer program listing appendix, which describes the programming of the programmable information processor.

### BRIEF DESCRIPTION OF THE DRAWINGS

FIG. 1 is a perspective view of a garage with a mounted garage door operator in accordance with the present invention;

FIG. 2 is a block diagram of a controller mounted within the head unit of the garage door operator shown in FIG. 1 with battery back-up circuit;

FIGS. 3-5 are flow diagrams of the battery back-up circuit showing monitoring of battery voltage and automatic notification;

FIG. 6 is a schematic diagram of the battery back-up circuit of the present invention showing the electrical interconnection and circuit components of back-up batteries and battery chargers; and

FIG. 7 is a schematic diagram of the battery back-up circuit in accordance with the present invention showing the electrical interconnection of processor, keypad, telephone line interface, and voice control chip.

### DETAILED DESCRIPTION OF THE PREFERRED EMBODIMENT

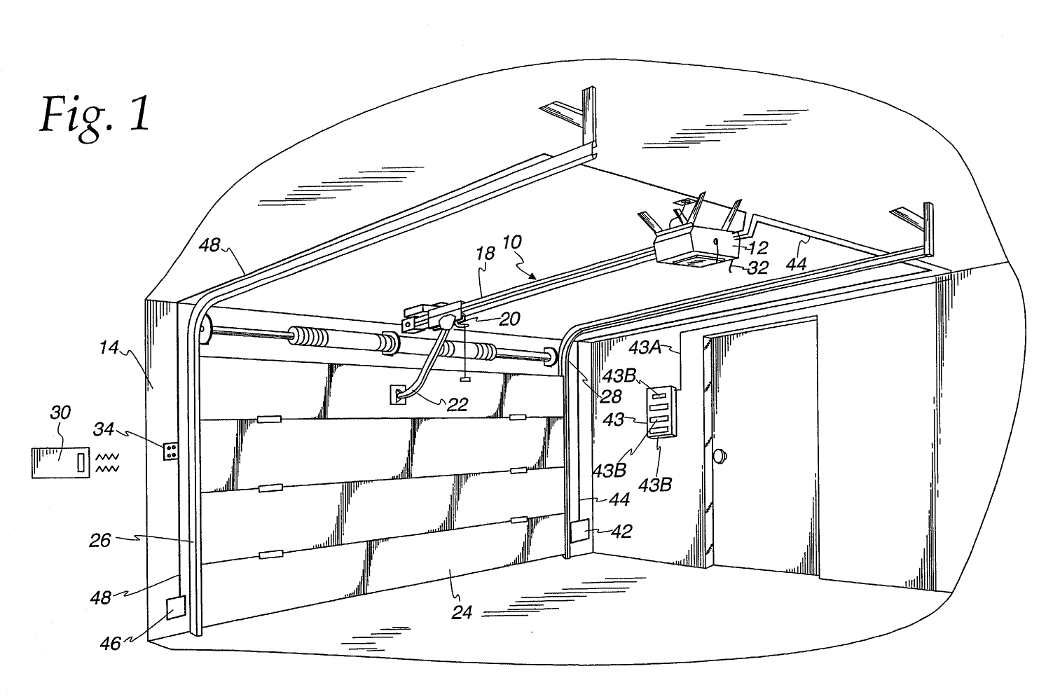

The present invention provides a back-up battery system such as for the garage door operator shown in FIG. 1. FIG. 1 generally shows a movable barrier door operator or garage door operator referenced to by numeral 10, which includes a head unit 12 mounted within a garage 14.

More specifically, the head unit 12 is mounted to the ceiling of the garage 14 and includes a transmission rail 18 extending therefrom with a releasable trolley 20 attached having an arm 22 extending to a multiple paneled garage door 24 positioned for movement along a pair of door rails 26 and 28. The system includes a hand-held transmitter unit 30 adapted to send signals to an antenna 32 positioned on the head unit 12 and coupled to a receiver as will appear hereinafter. An external control pad 34 is positioned on the outside of the garage having a plurality of buttons thereon and communicating via radio frequency transmission with the antenna 32 of the head unit 12. A wall control, or switch module, 43 is mounted on a wall of the garage. The switch module 43 is connected to the head unit 12 by a pair of wires 43a. The switch module and may include a plurality of switches 396 for the operation and programming of the garage door operator 10. An optical emitter 42 is connected via a power and signal line 44 to the head unit 12. An optical detector 46 is connected via a wire 48 to the head unit 12.

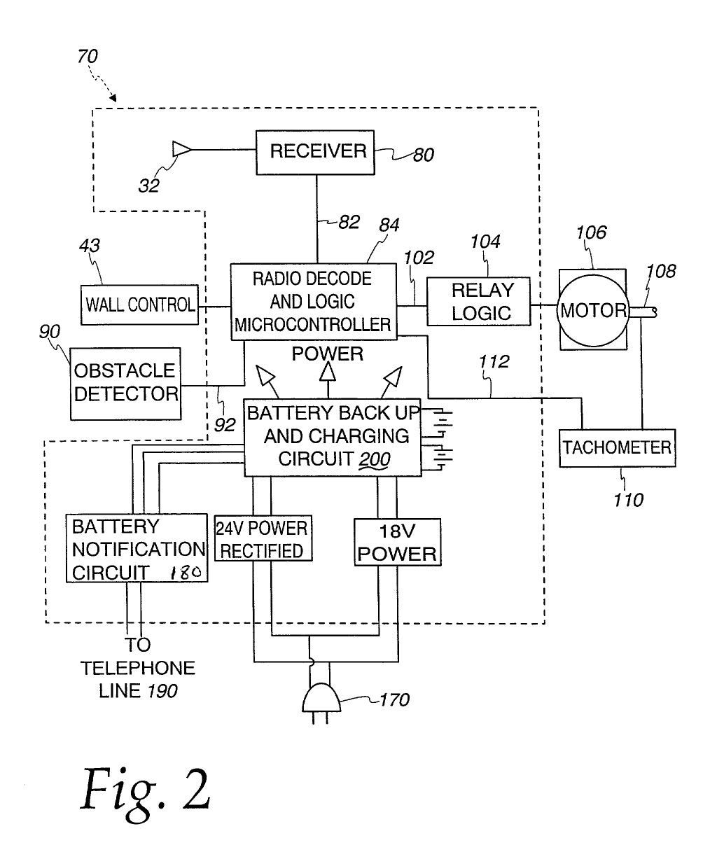

As shown in FIGS. 1 and 2, the garage door operator 10, which includes the head unit 12 has a controller 70 that includes the antenna 32. The controller 70 receives alternating current from an alternating current source, such as 110 volt AC, and converts the alternating current to required levels of DC voltage. The controller 70 includes a receiver 80 coupled via a line 82 to supply demodulated digital signals to a microcontroller 84. An obstacle detector 90, which comprises the emitter 42 and infrared detector 46 is coupled via an obstacle detector bus 92 to the microcontroller 84. The obstacle detector bus 92 includes lines 44 and 48. The wall control 43 is connected via the connecting wires 43a to the microcontroller 84. The microcontroller 84, in response to switch closures and received codes, will send signals over a relay logic line 102 to a relay logic module 104 connected to an alternating current motor 106 having a power take-off shaft 108 coupled to the transmission 18 of the garage door operator 10. A tachometer 110 is coupled to the shaft 108 and provides an RPM signal on a tachometer line 112 to the microcontroller 84; the tachometer signal being indicative of the speed of rotation of the motor 106.

As shown in FIG. 2, during ordinary usage (no external power failure), an external power source 170 provides the power for energizing the various components of the controller 70, including the battery back-up and charging circuit 200. As shown in FIG. 2, the external power source provides AC voltage, which is transformed and rectified to yield 18 volts DC. This 18 volt DC current is supplied to the battery backup and charging circuit 200 during ordinary usage to maintain the batteries in a charged state.

In addition, during ordinary usage (no external power failure), the external power source 170 provides 24 volts of rectified DC current to the battery back-up and charging circuit 200. During normal operation, this 24 volts is supplied through the garage door operator and represents power supplied to the garage door operator. When a power failure occurs, however, this 24 volts is no longer supplied to the battery back-up and charging circuit 200, and relays are energized to connect the battery back-up and charging circuit 200 to the garage door operator power board, as described hereinafter. Accordingly, during a power outage, the battery back-up and charging circuit 200 provides the power for energizing the various elements of the controller 70. Preferably, two 12-volt batteries B1 and B2 operate in series to provide the necessary back-up power.

Furthermore, as shown in FIG. 2, a battery notification circuit 180 is connected to the battery back-up and charging circuit 200. The battery notification circuit 180 periodically monitors the output voltage of the back-up batteries. When the output voltage falls below a predetermined level, the battery notification circuit 180 actuates a telephone line interface to dial a stored telephone number, which is transmitted over a telephone line 190.

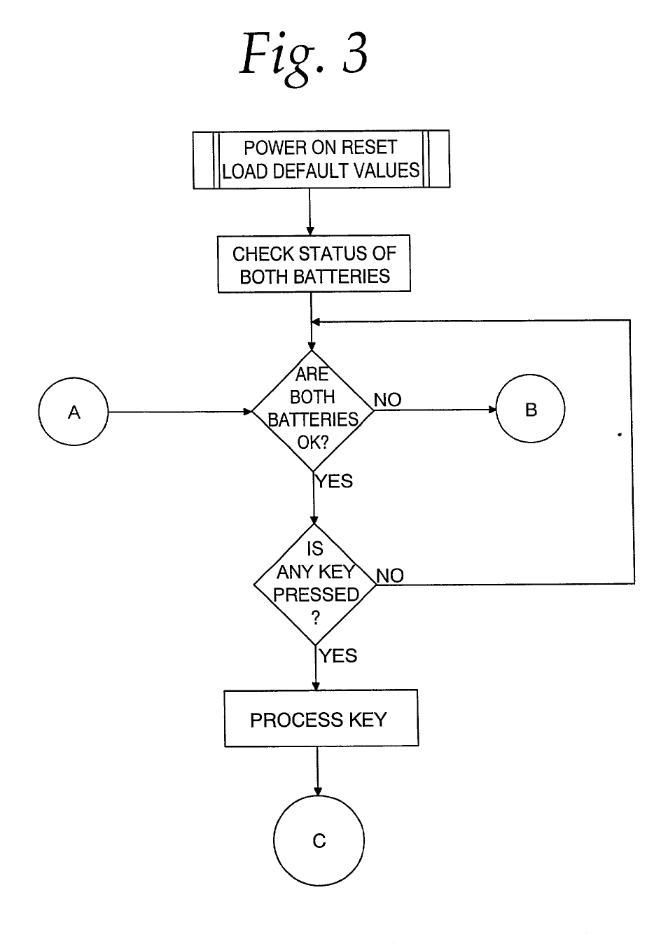

FIGS. 3-5 show the basic operation of the battery notification circuit 180. The present invention monitors back-up batteries B1 and B2 that are used in garage door operators to provide power in case of an external electrical power outage, or other external power failure, and initiates telephone notification to a predetermined telephone number. The system operates through the use of a programmable information processor 100, described more fully herein. The processor 100 operates the system by detecting battery voltage deterioration, actuating a telephone line interface 160 to dial out a stored telephone number, and then actuating the voice control chip 120 to play a stored telephone message.

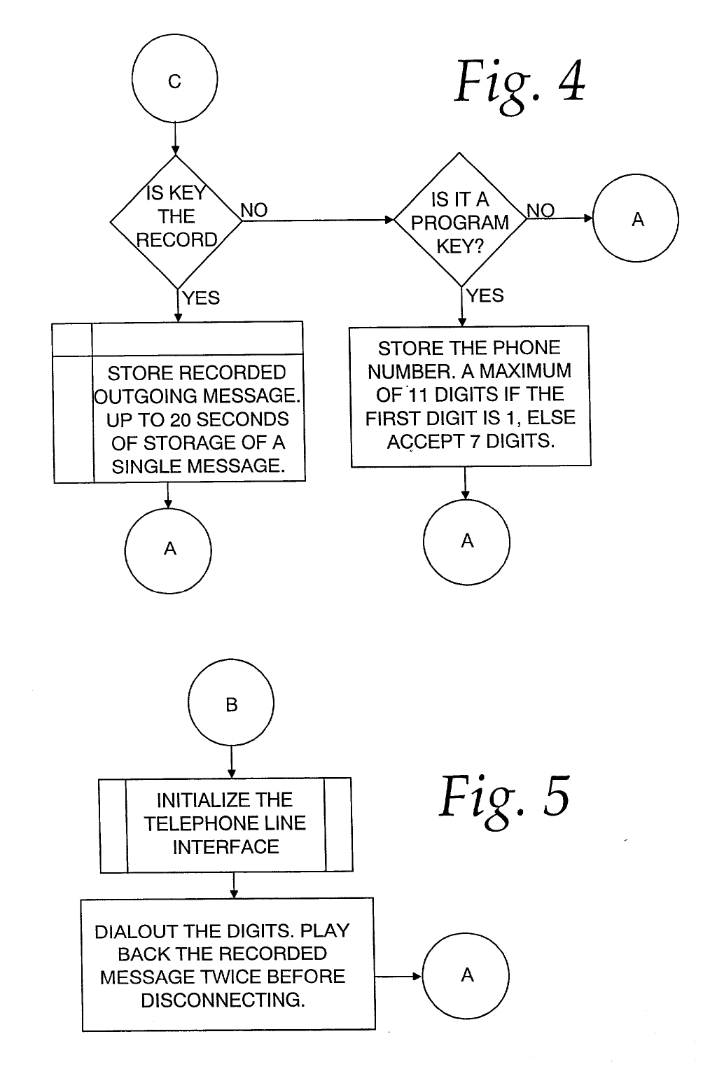

FIG. 3 shows operation of the main routine of the processor 100. As shown in FIG. 3, the processor 100 continually monitors the output voltage of one or more batteries B1 and B2 to determine if the voltages of one or more batteries B1 and B2 are above a predetermined level. To perform this operation, the main routine calls various subroutines, including two subroutines that are described herein: (1) a telephone dialing subroutine (FIG. 5), and (2) a user input subroutine (FIG. 4).

The telephone dialing subroutine is initiated if one or more battery voltages are below the predetermined voltage level, as shown by the letter “B” in FIGS. 3 and 5. As shown in FIG. 5, the processor 100 initializes the telephone line interface 160. The processor 100 and interface 160 dial out a stored telephone number and, in the preferred form, play a recorded telephone message twice before disconnecting. After the phone number has been dialed and the phone message played, the telephone dialing subroutine in FIG. 5 proceeds to letter “A,” which is simply a return to the main routine of FIG. 3. In the preferred form of the invention, as shown in FIG. 3, this dialing of a phone number and playing of a message is repeated after a predetermined amount of time has passed.

The user input subroutine is initiated to determine if the user is seeking to input a telephone number or telephone message. If the user presses any of the push buttons on a keypad, the main routine initiates the user input subroutine, shown as “C” in FIGS. 3 and 4.

As shown in FIG. 4, the user input subroutine determines if the user is seeking to record a telephone message that will be played if the back-up batteries need to be replaced. In the preferred form of the invention, the user records one or more phone messages by pressing the “record” key, and the messages are stored in the nonvolatile memory of a voice control chip 120. In the preferred form, the user can store a single outgoing message that is up to 20 seconds in length.

The user input subroutine also determines if the user is seeking to record a telephone number that will be dialed if the back-up batteries B1 and B2 need to be replaced. In the preferred form of the invention, the user records one or more telephone numbers by pressing the “program” key, and the numbers are stored in the non-volatile memory of the processor 100. In the preferred form, the user can store a phone number having a maximum of 11 digits (if the first digit inputted is a “1”) or alternatively 7 digits (if the first digit is not a “1”). After the user has inputted a phone number or message, the user input subroutine in FIG. 4 proceeds to letter “A,” which is simply a return to the main routine of FIG. 3.

As discussed above, FIGS. 3-5 show the operation of a back-up battery notification circuit 180 for a garage door operator, but this operation can be easily modified to monitor the condition of other garage door operator components and provide automatic notification. Instead of using circuits that monitor the back-up batteries B1 and B2, the voltage sensing circuits are modified and the processor is programmed to monitor the characteristics of other components. For example, various components might be monitored for faults, and fault codes corresponding to various component faults could be monitored by the processor 100. The processor 100 detects component faults, actuates a telephone line interface 160 to dial out a stored telephone number, and then actuates the voice control chip 120 to play a stored telephone message. The processor operates in the same basic manner as was described above for the monitoring of back-up batteries B1 and B2.

In addition, the preceding discussion has discussed notification through the use of a conventional telephone system, but this notification can also be performed by the internet through a phone line or any other internet connection system. The basis operation remains the same. The processor 100 monitors the condition of the battery back-ups and other components, and when the processor 100 detects a component fault, it actuates the internet connection system to provide notification of the component fault. The processor 100 includes internet initiating and terminating capabilities, such as the ability to establish and maintain Login and TCP/IP connections.

Similarly, although the preceding discussion has discussed notification by transmitting a stored telephone voice message, it should be understood that the processor 100 also can be programmed to transmit a stored fax message. Again, the basic operation remains the same but without use of the voice control chip 120. The processor 100 monitors the condition of the battery back-ups and other components, and when the processor 100 detects a component fault, it actuates the telephone line interface 160 to provide notification of the component fault. The processor 100 then transmits a stored fax message, which may be stored in a non-volatile memory.

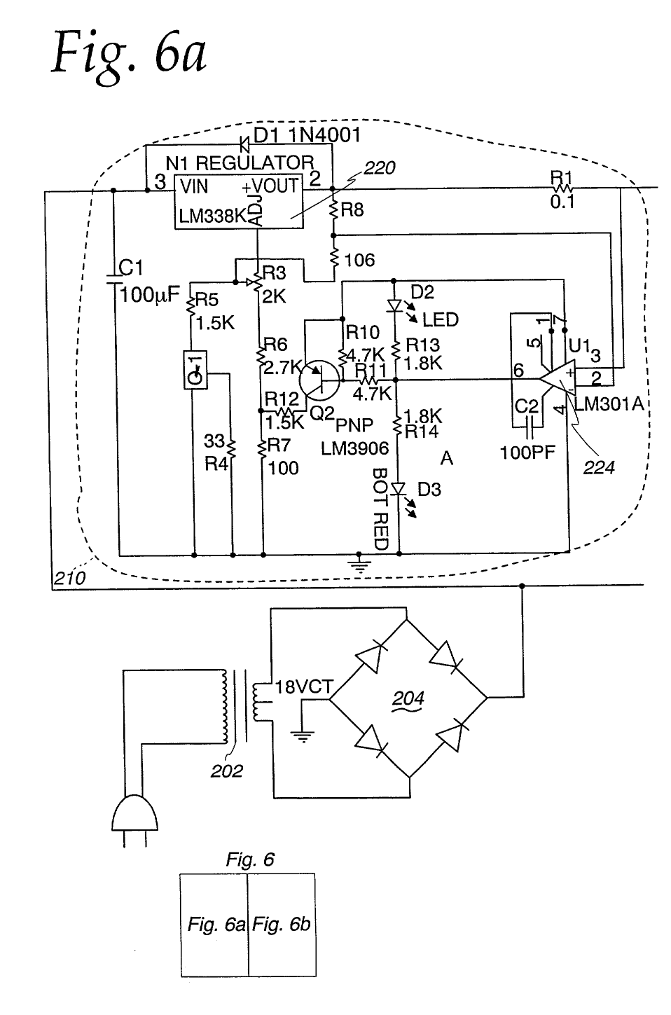

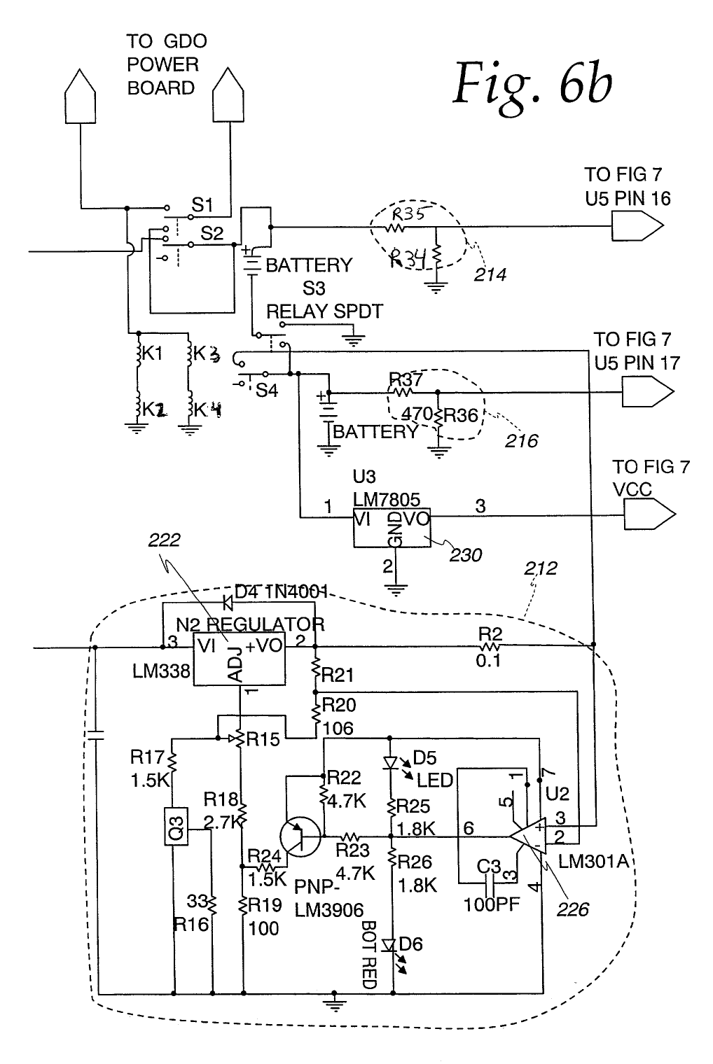

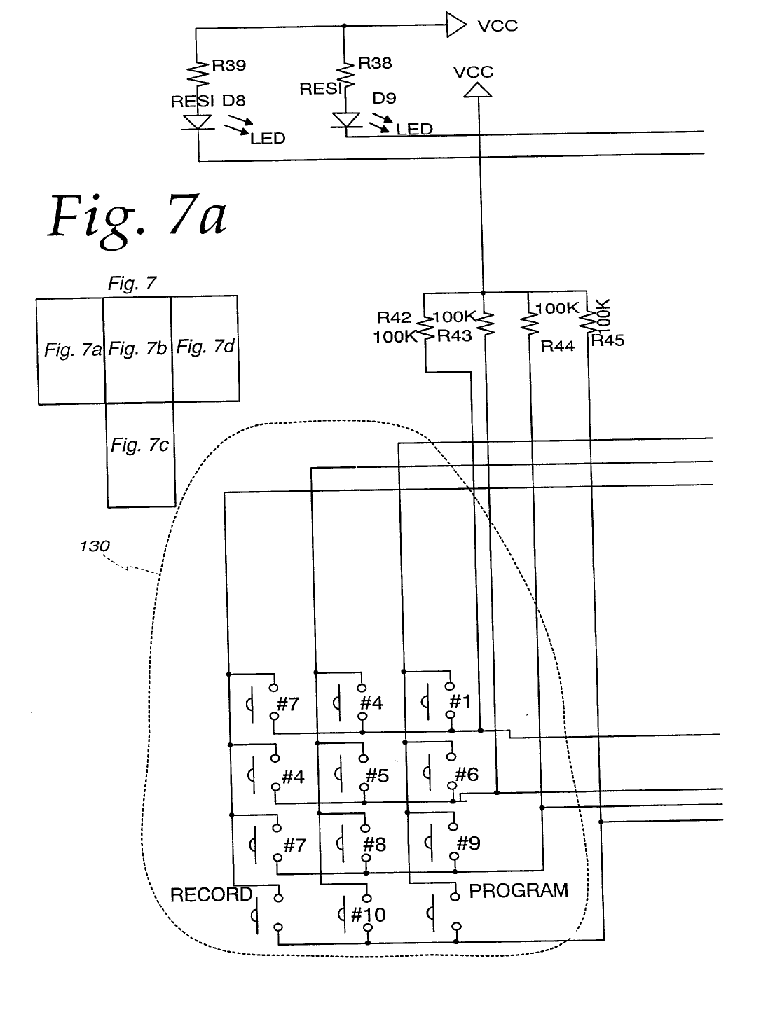

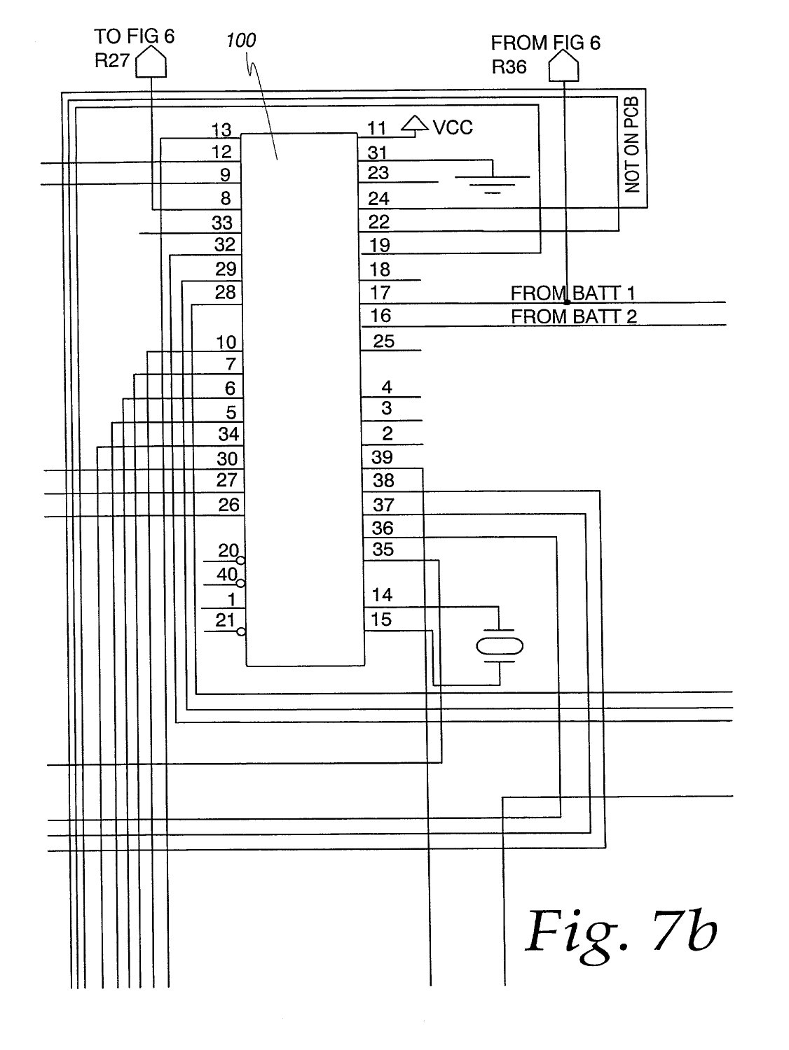

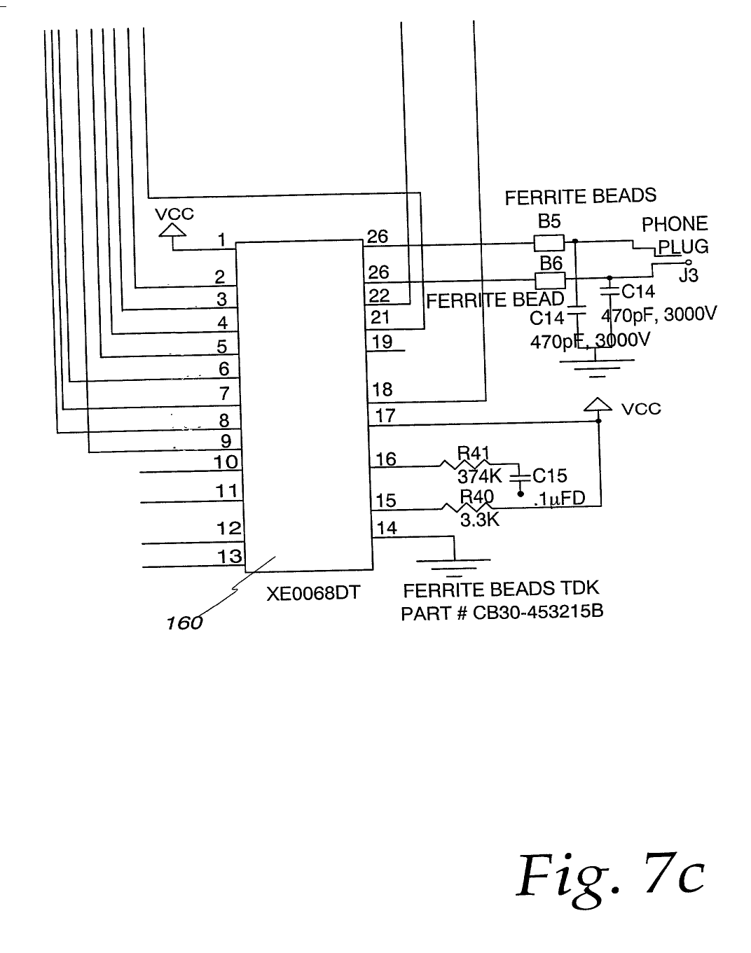

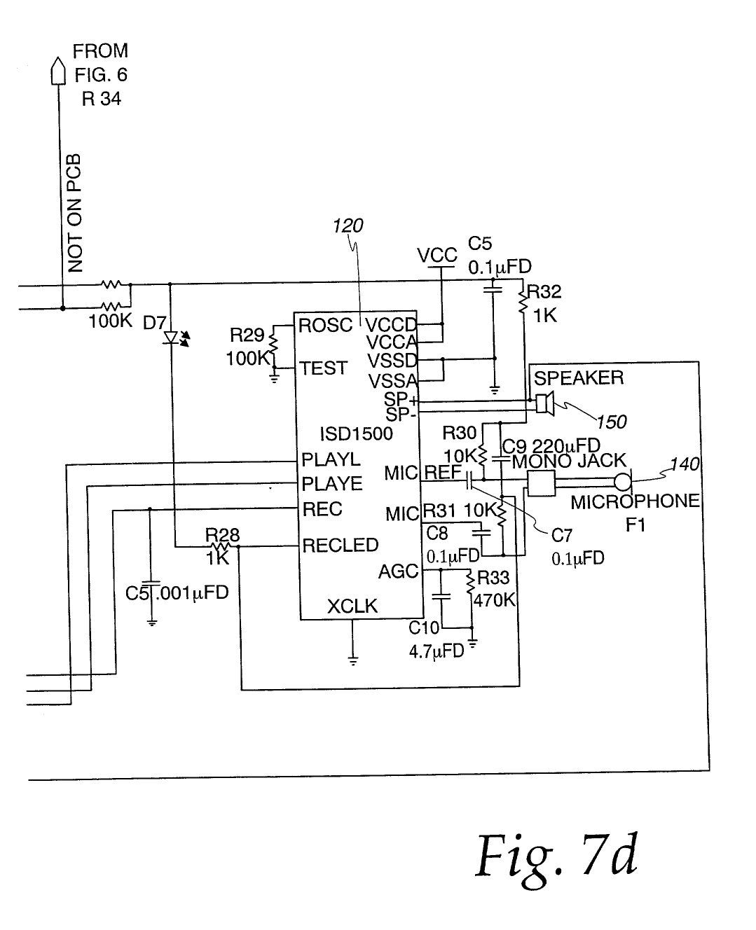

FIGS. 6 and 7 show schematic diagrams of two illustrative circuits, which disclose the battery back-up charging, monitoring, and automatic notification features of the present invention. These illustrative circuits show the electrical interconnection of components, some of which have been described above. More specifically, the illustrative circuits show the electrical interconnection of various components, such as the following: batteries B1 and B2, battery chargers 210 and 212, battery voltage sensing circuits 214 and 216, processor 100, keypad 130, telephone line interface 160, and voice control chip 120.

FIG. 6 shows generally the back-up battery and charging circuit 200 of FIG. 2. More specifically, FIG. 6 shows two batteries B1 and B2, two battery chargers 210 and 212, and two battery voltage dividers 214 and 216 used in the present invention.

In the preferred form of the invention, two back-up batteries B1 and B2 provide voltage to the garage door operator 10 if there is an external power failure. The backup batteries B1 and B2 are each preferentially 12 volt lead acid batteries and, during a power failure, are connected in series to provide the necessary 24 volt output voltage.

The charging of batteries and the supplying of battery back-up power are controlled by switches S1, S2, S3, and S4, as shown in FIG. 6. During ordinary operation of the garage door operator (no external power failure), the batteries B1 and B2 are connected to the battery chargers 210 and 212 to allow charging. More specifically, switches S2 and S4 are closed to connect the batteries B1 and B2 to the battery chargers 210 and 212. In addition, during ordinary operation, the batteries B1 and B2 do not supply back-up power to the garage door operator components. Thus, switches S1 and S3 are open so that the batteries B1 and B2 are not connected to the garage door operator components and are not connected in series to each other.

When the garage door operator experiences a loss of external power, this loss of power cycles relays K1, K2, K3, and K4 to operate the corresponding switches S1, S2, S3, and S4. First, the batteries B1 and B2 are disconnected from the battery chargers 210 and 212. More specifically, switches S2 and S4 are switched to the open position to disconnect batteries B1 and B2 from their respective battery chargers 210 and 212. Second, back-up power is supplied to the garage door operator components. More specifically, switch S1 is closed to connect the batteries B1 and B2 to the garage door operator components and switch S3 is closed to connect the batteries B1 and B2 to each other so that they operate in series. The use of this switching technique prevents significant dissipation of power.

The charging operation of the battery chargers 210 and 212 is now described in detail. The battery chargers 210 and 212 operate in two modes: a charging mode and a floating mode. In the charging mode, the battery chargers 210 and 212 provide a relatively high charging voltage to the respective batteries B1 and B2, such as 13.5 volts at room temperature. In the floating mode, the battery chargers 210 and 212 provide a relatively low charging voltage, such as 12.35 volts at room temperature. The lower charging voltage prevents each battery B1 and B2 from overcharging and possibly reducing battery life.

These high and low charging voltages vary as the external temperature changes: the charging voltages decrease as the temperature rises. This dependence of charging voltage on temperature protects the battery and extends battery life. A high temperature and relatively high voltage results in elevated battery temperatures, which leads to loss of electrolyte by evaporation. By reducing the charging voltage at high external temperatures, the loss of electrolyte is reduced and battery life is extended.

As shown in FIG. 6, the circuit is supplied with AC line voltage from an external source. A transformer 202 and rectifier 204 convert this AC line voltage to an unregulated DC supply of approximately 18 volts. The battery chargers 210 and 212 use their own transformer 202 so as not to load other garage door operator components. As shown in FIG. 6, rectified DC voltage is fed to each battery charging circuit 210 and 212.

With respect to battery charger 210, the rectified DC voltage is applied to pin 3 of voltage regulator 220. Voltage regulator 220 is protected by a diode D1, which prevents the battery B1 from backfeeding through the regulator 220. The voltage regulator 220 maintains a fixed voltage difference between pins 1 and 2, preferably a voltage difference of approximately 1.24 volts. The output of the voltage regulator 220 provides either a relatively high initial charging voltage or a lower float charging voltage to B1 depending on the mode of operation. In the preferred embodiment, the voltage regulator 220 provides a charging voltage to B1 of approximately 13.5 volts at room temperature when the battery charger 210 is in charging mode and a voltage of approximately 12.35 volts when in float mode. The output of the voltage regulator 220 can be set by adjusting resistor R3. In addition, the difference between the charging and float mode voltages is set by the ratio of resistors R3 and R7.

The output of the voltage regulator 220 is controlled by the transistor Q2 and the comparator 224. The comparator 224 compares the voltages across resistors R1 and R9 with R9 acting as a fixed reference. Transistor Q2 will be turned ON whenever the voltage across R1 exceeds the voltage across R9 (charging mode). When Q2 is turned ON, the voltage to the regulator 220 is increased, which in turn provides the higher charging voltage to B1. Transistor Q2 will be turned OFF whenever the voltage across R1 is less than the voltage across R9 (floating mode). In turn, this decreases the voltage to the regulator 220, which provides the lower charging voltage to B1.

In the preferred embodiment, the threshold for current through R1 is approximately 380 mA. As the battery B1 initially charges, the charging current through R1 will initially start at a high level but will reduce over time. At some point, as the battery B1 becomes more fully charged, the charging current will drop below the threshold of 380 mA. In turn, the comparator 224 will detect the decrease of charging current below the predetermined level across R1 and will turn OFF transistor Q2. The circuit 210 then enters into the float charging mode and the charging voltage is reduced to approximately 12.35 V.

In the preferred embodiment, the comparator 224 is an LM301A integrated circuit comparator, although other general purpose comparators may be used. In addition, the voltage regulator 220 is an LM338 regulator and the PNP transistor Q2 is an LM3906, although other general purpose components may be used. Furthermore, as shown in FIG. 6, a red LED D3 indicates that the battery B1 is in the initial charging mode while a green LED D2 indicates that initial charging is completed and that the circuit 210 is in float charging mode.

The above description discusses the operation of battery-charging circuit 210 and charging voltages when the battery back-up is at room temperature. As shown in FIG. 6, an adjustable current source Q1 is used in the battery charger 210 to adjust the initial and float charging voltages based on temperature. High voltage and high temperature reduce battery life. The use of the temperature-dependent current source Q1 results in lower initial and float charging voltages at higher temperatures, thereby increasing battery life.

More specifically, a relatively high temperature at Q1 results in increased output current at Q1. In turn, this increased current results in reduced voltage at pin 1 of the voltage regulator 220, which results in a reduced output voltage of the voltage regulator 220. In the preferred embodiment, Q1 is an LM334 device, although other temperature-dependent devices might be used. The LM334 device provides an increase in output current of approximately 0.33% per degree Celsius.

The operation of the battery chargers 210 and 212 has been described generally with respect to battery charger 210. The same basic description, of course, applies to the operation of battery charger 212. As can be seen in FIG. 6, battery charger 212 works in the same manner with corresponding circuit components.

FIG. 6 also shows the voltage dividers 214 and 216, which are used to monitor voltages of batteries B1 and B2 to determine if they fall below a predetermined level and need replacement. Each voltage divider includes two resistors: voltage divider 214 includes R34 and R35 and voltage divider 216 includes R36 and R37. The voltage dividers 214 and 216 are connected to two pins of the processor 100 (to pins 16 and 17 as shown in FIG. 7), which allows the processor 100 to actively monitor the voltage status of the batteries B1 and B2. In the preferred form, this monitoring occurs every eight seconds.

FIG. 7 shows generally the battery notification circuit 180 of FIG. 2. More specifically, FIG. 7 shows the processor 100, the voice control chip 120, the telephone line interface 160, and the keypad push button switches 130 of the present invention. As shown in FIG. 7, the processor 100 is operatively connected to other components. In the preferred embodiment, the processor 100 is a Zilog Z86L73 integrated circuit, although other general purpose microprocessors or microcontrollers may be used. The processor 100 also has a memory, which may comprise a non-volatile memory, to allow the storage of telephone numbers inputted by the user, as described further below.

As shown in FIG. 7, the keypad 130 includes a number of push button switches to allow a user to input telephone numbers and messages. In the preferred embodiment, the keypad 130 has 12 push button switches corresponding to keys for the digits 0-9, a “record” key, and a “program” key. To input a telephone message, a user presses the “record” key and then utters the message to be played.

To input a telephone number, a user presses the “program” key followed by the digits of the telephone number to be called if battery voltage falls below a predetermined value. If the first digit entered by the user is a “1,” the user may enter ten more digits. Otherwise, the user is permitted to enter six more digits corresponding to a standard telephone number in the same area code. During recording and programming, LEDs D8 and D9 shown in FIG. 7 will be illuminated respectively.

The telephone line interface 160 is actuated by the processor 100 when the processor 100 detects a low voltage condition. In turn, the interface 160 operates on an analog touch-tone enabled telephone line to dial the touch-tone codes corresponding to the digits of the stored telephone number. In the preferred embodiment, the telephone line interface 160 is a XECOM XE0068DT integrated circuit, although other general purpose telephone line interfaces may be used.

The voice control chip 120 is also actuated by the processor 100 when the processor 100 detects a low voltage condition. In the preferred embodiment, the voice control chip 120 is an ISD1500 integrated circuit, although other general purpose voice control chips may be used. The chip 120 has a non-volatile memory and is used for the recording of and the playback of a telephone message. Recording is accomplished by use of a microphone 140 operatively connected to the chip 120, and playback of a recorded message is accomplished by use of a speaker 150 operatively connected to the chip 120.

Voltage is supplied to power the battery back-up components through voltage regulator 230, which is shown in FIG. 6. In the preferred embodiment, an LM7805 3-terminal voltage regulator is used to supply a fixed voltage to the components, although other general purpose voltage regulators could be used. During ordinary operation (no external power failure), the regulator 230 receives an input voltage from battery charger 212 in excess of 5 volts, sheds voltage through thermal power loss, and provides a steady 5 volt output. This 5 volt output is used to power circuit components, such as the processor 100, voice control chip 120, number keypad 130, telephone line interface 160, and LEDs D8 and D9, as shown in FIG. 7. During an external power failure, input voltage is supplied to the voltage regulator 230 from battery B2, and the regulator 230 again supplies steady 5 volt output to the battery back-up components.

It should be understood that the values for the components shown in FIGS. 6 and 7 are illustrative only. The specific numerical values of the specific components, and even the specific combinations of particular components illustrated are understood to be representative only, and variations therein may be made by one of average skill in the art. In addition, the software/programming which will enable the invention to perform its desired function may be readily modified by one of average skill in the art. Thus, while there have been illustrated and described particular embodiments of the present invention, it will be appreciated that numerous changes and modifications will occur to those skilled in the art, and it is intended in the appended claims to cover all those changes and modifications which fall within the scope of the present invention.

Similarly, as discussed above, the programmable information processor can be programmed to monitor other components of garage door operators and initiate a service call for preventative maintenance. The circuit operates in the same basic manner through use of a programmable information processor, a number keypad, a telephone line interface, and a voice control chip. Instead of using a battery voltage sensing circuit, however, the present invention uses a circuit that senses component faults. Fault codes corresponding to various component faults can be monitored by the processor 100, which in turn can acuate the notification system, as discussed generally above. In addition, as discussed above, notification can also be performed by the internet through a phone line or any other internet connection system.

The appendix attached hereto includes a source code listing of a series of routines used to operate a back-up battery monitoring and notification device in accordance with the present invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A battery monitoring and automatic notification system comprising:
one or more batteries;
one or more battery charging circuits to maintain each battery in a charged state;
a telephone line interface for automatically dialing out a predetermined telephone number over a telephone network;
a voice control chip for recording one or more telephone messages and for playing one or more stored telephone messages;
one or more circuits to sense battery voltage; and
a programmable information processor operatively connected to the telephone line interface, the voice control chip, and the one or more battery voltage sensing circuits.

2. The system of claim 1 wherein the processor is operative to detect when the output voltage of one or more batteries falls below a predetermined level, to actuate the telephone line interface to dial out a stored telephone number, and to actuate the voice control chip to play a stored message.

3. The system of claim 1 wherein the voice control chip has a non-volatile memory for storing one or more telephone messages.

4. The system of claim 1 wherein the voice control chip is operatively connected to a microphone for recording one or more telephone messages.

5. The system of claim 1 wherein the voice control chip is operatively connected to a speaker for playing one or more stored telephone messages.

6. The system of claim 1 wherein the processor has a non-volatile memory for storing one or more telephone numbers.

7. The system of claim 1 further comprising a number keypad, operatively connected to the processor, with push buttons to allow a user to input one or more telephone numbers or messages.

8. The system of claim 7 wherein the number keypad comprises a record push button, a program push button, and push buttons representing the digits 0 through 9.

9. The system of claim 1 wherein one or more of the circuits that monitor battery voltage comprise a voltage divider connected to the processor.

10. The system of claim 1 wherein each battery charging circuit supplies a battery with a variable charging current and provides one of two charging voltages to the battery depending on the level of the charging current.

11. The system of claim 10 wherein each battery charging circuit comprises:
a comparator that compares a voltage corresponding to the charging current with a predetermined reference voltage and that provides two different outputs based on whether the voltage corresponding to the charging current is above or below the predetermined reference voltage;
and a voltage regulator that applies a charging voltage to a battery based on the output of the comparator, applying one charging voltage when the comparator output is low and applying a second charging voltage when the comparator output is high.

12. The system according to claim 11 wherein each battery charging circuit further comprises:
an adjustable current source that reduces the charging voltage of the battery as the temperature of the adjustable current source increases.

13. A combination garage door operator and battery back-up monitoring and automatic notification system, the system comprising:
an electric motor;
a transmission connected to the electric motor to be driven thereby and for connection to a movable barrier to be moved with respect to a barrier frame;
a controller for energizing the electric motor to move the movable barrier, said controller including a back-up battery circuit;
wherein the back-up battery circuit further comprises:
one or more batteries;
a telephone line interface for automatically dialing out a predetermined telephone number over a telephone network;
a voice control chip for recording a telephone message and for playing a stored telephone message;
one or more circuits to sense battery voltage; and
a programmable information processor operatively connected to the telephone line interface, the voice control chip, and the one or more battery voltage sensing circuits.

14. The system of claim 13 wherein the processor is operative to detect when the output voltage of one or more batteries falls below a predetermined level, to actuate the telephone line interface to dial out a stored telephone number, and to actuate the voice control chip to play a stored message.

15. The system of claim 13 wherein the voice control chip has a non-volatile memory for storing one or more telephone messages.

16. The system of claim 13 wherein the voice control chip is connected to a microphone for recording one or more telephone messages.

17. The system of claim 13 wherein the voice control chip is connected to a speaker for playing one or more stored telephone messages.

18. The system of claim 13 wherein the processor has a non-volatile memory to store one or more telephone numbers.

19. The system of claim 13 further comprising a number keypad, operatively connected to the processor, with push buttons to allow a user to input one or more telephone numbers and messages.

20. The system of claim 19 wherein the number keypad comprises a record push button, a program push button, and push buttons representing the digits 0 through 9.

21. The system of claim 13 wherein one or more of the circuits that monitor battery voltage comprise a voltage divider connected to the processor.

22. The system of claim 13 further comprising one or more battery charging circuits to maintain each battery in a charged state wherein each battery charging circuit supplies a battery with a variable charging current and provides one of two charging voltages depending on the level of the charging current.

23. The system of claim 22 wherein each battery circuit comprises:
a comparator that compares a voltage corresponding to the charging current with a predetermined reference voltage and that provides two different outputs based on whether the voltage corresponding to the charging current is above or below the predetermined reference voltage; and
a voltage regulator that applies a charging voltage to a battery based on the output of the comparator, applying one charging voltage when the comparator output is low and applying a second charging voltage when the comparator output is high.

24. The system according to claim 23 wherein each battery charging circuit further comprises:
an adjustable current source that reduces the charging voltage as the temperature of the adjustable current source increases.

25. A combination garage door operator and battery back-up and recharging system, the system comprising:
an electric motor;
a transmission connected to the electric motor to be driven thereby and for connection to a movable barrier to be moved with respect to a barrier frame; and
a controller for energizing the electric motor to move the movable barrier, said controller including a back-up battery and charging circuit;
wherein the back-up battery and charging circuit supplies a battery with a variable charging current and provides one of two charging voltages to the battery depending on the level of the charging current.

26. The combination according to claim 25 wherein the back-up battery and charging circuit comprises:
a comparator that compares a voltage corresponding to the charging current with a predetermined reference voltage and that provides two different outputs based on whether the voltage corresponding to the charging current is above or below the predetermined reference voltage; and
a voltage regulator that applies a charging voltage to a battery based on the output of the comparator, applying one charging voltage when the comparator output is low and applying a second charging voltage when the comparator output is high.

27. The combination according to claim 26 wherein the battery back-up and charging circuit further comprises:
an adjustable current source that reduces the charging voltage as the temperature of the adjustable current source increases.

28. A method for monitoring and reporting the condition of a component comprising:
monitoring the condition of the component;
detecting if a defective component condition exists;
initializing a telephone line interface;
dialing a stored telephone number; and
transmitting a stored telephone message.

29. The method of claim 28, further comprising redialing the stored telephone number and re-transmitting the stored telephone message after a predetermined amount of time has elapsed.

30. The method of claim 28, wherein the stored telephone message is a facsimile communication.

31. A method of operating a garage door operator having a battery back-up circuit, the method comprising:
energizing the garage door operator using an external source of AC power, when available, and using back-up batteries when an external source of AC power is not available;
monitoring the condition of one or more back-up batteries;
detecting if a low battery voltage condition exists;
initializing a telephone line interface;
dialing a stored telephone number; and
transmitting a stored telephone message.

32. The method of claim 31, further comprising using battery charging circuits to maintain the back-up batteries in a charged state.

33. The method of claim 31, further comprising redialing the stored telephone number and re-transmitting the stored telephone message after a predetermined amount of time has elapsed.

34. The method of claim 31 wherein the stored telephone message is a facsimile communication.

35. A combination garage door operator and battery back-up monitoring and automatic notification system, the system comprising:
an electric motor;
a transmission connected to the electric motor to be driven thereby and for connection to a movable barrier to be moved with respect to a barrier frame;
a controller for energizing the electric motor to move the movable barrier, said controller including a back-up battery circuit;
wherein the back-up battery circuit further comprises:
one or more batteries;
an internet connection system;
one or more circuits to sense battery voltage; and
a programmable information processor operatively connected to the internet connection system and to the one or more battery voltage sensing circuits.

36. The system of claim 35 wherein the processor is operative to detect when the output voltage of one or more batteries falls below a predetermined level, to actuate the internet connection system, and to transmit a stored message.
